(19) United States
(12) Patent Application Publication
(10) Pub. No.: US 2024/0186725 A1
(43) Pub. Date: Jun. 6, 2024

(54) TERMINAL-EQUIPPED WIRE AND METHOD FOR MANUFACTURING TERMINAL-EQUIPPED WIRE

(71) Applicant: YAZAKI CORPORATION, Tokyo (JP)

(72) Inventor: Takahiro Yudate, Makinohara-shi (JP)

(21) Appl. No.: 18/522,240

(22) Filed: Nov. 29, 2023

(30) Foreign Application Priority Data
Dec. 5, 2022 (JP) 2022-194247

(51) Int. Cl. H01R 4/18; H01R 43/048

(52) U.S. Cl. CPC H01R 4/185; H01R 43/048

(57) ABSTRACT

In a terminal-equipped wire, a conductor exposed portion of a wire constitutes a solid wire portion obtained by solidifying a plurality of strands into a solid wire, and wire-side uneven patterns are formed on surfaces of the solid wire portion. In a wire crimp portion of a crimp terminal, a terminal-side uneven pattern is formed along an axial direction on a surface that comes into contact with the conductor exposed portion. In a crimped state where the wire crimp portion is crimped to the conductor exposed portion, the conductor exposed portion and the wire crimp portion have protrusions in the wire-side uneven patterns and protrusions in the terminal-side uneven pattern brought into contact with each other at least at one point.

### CROSS-REFERENCE TO RELATED APPLICATION(S)

The present application claims priority to and incorporates by reference the entire contents of Japanese Patent Application No. 2022-194247 filed in Japan on Dec. 5, 2022.

### BACKGROUND OF THE INVENTION

### 1. Field of the Invention

The present invention relates to a terminal-equipped wire and a method for manufacturing a terminal-equipped wire.

### 2. Description of the Related Art

In a known terminal-equipped wire, for example, a wire having a conductor including a plurality of strands covered with an insulating sheath has an exposed end, and a wire crimp portion of a crimp terminal is crimped to the conductor (conductor exposed portion) (see, for example, Japanese Patent No. 6163149)

In the terminal-equipped wire disclosed in Japanese Patent No. 6163149, ultrasonic vibration is applied to the conductor exposed portion before the wire crimp portion of the crimp terminal is crimped, thereby making the conductor exposed portion into a solid wire.

The terminal-equipped wire disclosed in Japanese Patent No. 6163149 is provided with a solid wire by the application of ultrasonic vibration to the conductor exposed portion for the purpose of bonding between the plurality of strands included in the conductor exposed portion of the wire. However, there is room for improvement in efficiently breaking a metal oxide film formed on surfaces of the conductor exposed portion and the wire crimp portion.

### SUMMARY OF THE INVENTION

An object of the present invention is to provide a terminal-equipped wire and a method for manufacturing a terminal-equipped wire which enable efficient breaking of a metal oxide film between a wire and a crimp terminal.

In order to achieve the above mentioned object, a terminal-equipped wire according to one aspect of the present invention includes a wire in which a conductor having conductivity is sheathed with an insulating sheath having an insulating property; and a crimp terminal including a wire crimp portion crimped to an end of the insulating sheath and a conductor exposed portion which is a part of the conductor exposed from the end, and an electrical connecting portion coupled to the wire crimp portion to be conductive and electrically connected to a mating terminal, wherein the conductor exposed portion has a solid wire portion formed by solidifying a plurality of strands into a solid wire and a wire-side uneven pattern formed on a surface of the solid wire portion along an axial direction of the wire, the wire crimp portion has a terminal-side uneven pattern formed along the axial direction on a contact surface in contact with the conductor exposed portion, and the conductor exposed portion and the wire crimp portion have protrusions in the wire-side uneven pattern and protrusions in the terminal-side uneven pattern brought into contact with each other at least at one point in a crimped state where the wire crimp portion is crimped to the conductor exposed portion.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is an exploded perspective view illustrating a schematic configuration of a terminal-equipped wire according to an embodiment;

FIG. 2 is a developed view illustrating the schematic configuration of the terminal-equipped wire according to the embodiment;

FIG. 3 is a schematic cross-sectional view illustrating a cross section of a conductor exposed portion and a wire crimp portion of the terminal-equipped wire according to the embodiment when viewed from an axial direction;

FIG. 4 is a schematic cross-sectional view illustrating a cross section of the conductor exposed portion and the wire crimp portion of the terminal-equipped wire according to the embodiment when viewed from a width direction;

FIG. 5 is an enlarged view schematically illustrating contact between a wire-side uneven pattern and a terminal-side uneven pattern in a range P illustrated in FIG. 4;

FIG. 6 is a flowchart illustrating a method for manufacturing the terminal-equipped wire according to the embodiment;

FIG. 7 is a side view schematically illustrating the conductor exposed portion before first processing;

FIG. 8 is a side view schematically illustrating the conductor exposed portion being processed in the first processing;

FIG. 9 is a side view schematically illustrating a solid wire portion after the first processing;

FIG. 10 is a schematic view illustrating contact between the wire-side uneven pattern and the terminal-side uneven pattern according to a modification of the embodiment; and

FIG. 11 is a schematic view illustrating contact between the wire-side uneven pattern and the terminal-side uneven pattern according to a modification of the embodiment.

### DETAILED DESCRIPTION OF THE PREFERRED EMBODIMENTS

Hereinafter, an embodiment according to the present invention will be described in detail with reference to the drawings. It should be noted that the present invention is not limited by this embodiment. That is to say, the following embodiment include components that can be easily assumed by those skilled in the art or components that are substantially identical and can be omitted, substituted, or changed in various ways without departing from the gist of the invention.

### Embodiment

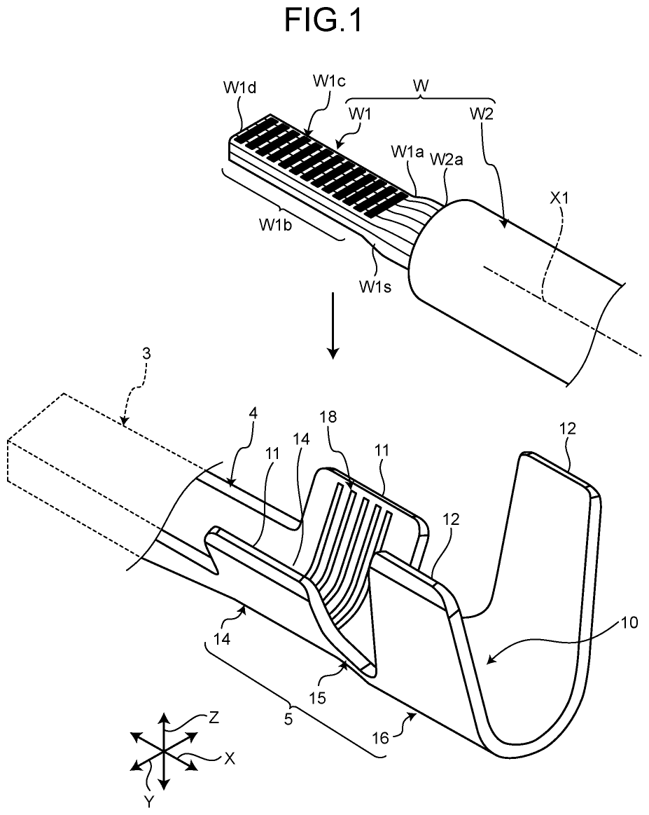

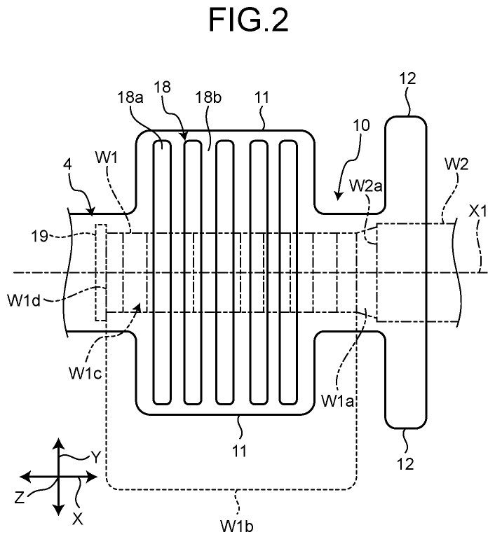

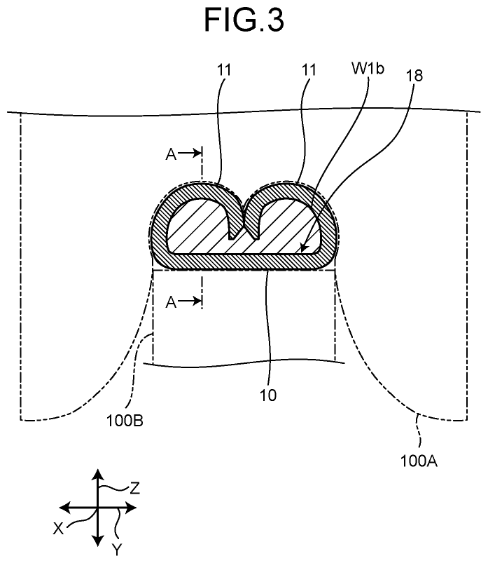

First, a terminal-equipped wire 1 of this embodiment will be described with reference to FIGS. 1 to 5. The terminal-equipped wire 1 of this embodiment is applied to a wire harness or the like used in a vehicle. In order to connect vehicle-mounted electrical devices with each other, for example, a wire harness is designed in such a manner that a plurality of wires W used for power supply or signal communication is bundled into as a collective assembly and the plurality of wires W is connected with the electrical devices by connectors. FIGS. 1 and 2 illustrate a crimp terminal and a wire before the crimp terminal is crimped to an end of the wire. FIG. 3 illustrates the crimp terminal after crimping.

The terminal-equipped wire 1 of this embodiment includes a wire W and a crimp terminal 2 crimped to and conductively connected with an end of the wire W.

In the following description, X direction in the drawings is referred to as “axial direction X”, Y direction in the drawings is referred to as “width direction Y”, and Z direction in the drawings is referred to as “height direction Z.” The axial direction X, the width direction Y, and the height direction Z are perpendicular to each other. The axial direction X corresponds to a direction along an axis X1 (see, for example, FIG. 1) of the wire W where the illustrated crimp terminal 2 is to be disposed, a direction in which the wire W extends (extending direction), or a direction in which the crimp terminal 2 is inserted into or removed from a mating terminal (not illustrated). The width direction Y and the height direction Z correspond to directions that intersect the axial direction X. In addition, each direction used in the following description signifies a direction in a state where parts are assembled to each other unless otherwise specified.

The wire W is routed in a vehicle and electrically connects devices with each to other. As illustrated in FIG. 1, the wire W includes a linear conductor W1 having conductivity and an insulating sheath W2 that has insulating properties and covers the outer side of the conductor W1. The wire W is an insulative wire having the conductor W1 sheathed with the insulating sheath W2.

The conductor W1 is a core wire obtained by bundling a plurality of metal strands W1s having conductivity. The conductor W1 of this embodiment is a core wire obtained by bundling a plurality of strands of conductive metal such as copper, a copper alloy, aluminum, and an aluminum alloy, but may be a twisted core wire obtained by twisting the plurality of strands W1s. The insulating sheath W2 is a wire sheath that sheathes the outer periphery of the conductor W1. The insulating sheath W2 is formed by extruding an insulating resin material (such as polypropylene (PP), polyvinyl chloride (PVC), and cross-linked polyethylene (PE)). The material is appropriately selected in consideration of abrasion resistance, chemical resistance, heat resistance, and the like) .

The wire W extends linearly along the axis X1, having a substantially equal-sized diameter relative to the extending direction (axial direction X). The overall wire W has a substantially circular cross section. In the wire W, the conductor W1 has a substantially circular cross section (cross section in a direction intersecting the axial direction X), and the insulating sheath W2 has a substantially annular cross section along a circumferential direction D1. At least one end of the wire W has the insulating sheath W2 peeled off, and the conductor W1 is exposed from an end W2a of the insulating sheath W2. In the wire W, the crimp terminal 2 is disposed close to the end W2a of the insulating sheath W2 and on a conductor exposed portion W1a exposed from the end W2a of the insulating sheath W2.

The conductor exposed portion W1a has a solid wire portion W1b formed by solidifying the plurality of strands W1s into a solid wire. The solid wire portion W1b is obtained by mechanically deforming the conductor exposed portion Wia by processing which is to be described later. As illustrated in FIG. 1, the solid wire portion W1b is disposed between one end W1d of the conductor exposed portion W1a in the axial direction X and the end W2a of the insulating sheath W2. Note that the end Wid in the conductor exposed portion W1a is identified with one end of the solid wire portion W1b in the axial direction X. Unlike the conductor W1 having a circular cross section when viewed from the axial direction X, the solid wire portion W1b has a rectangular cross section having a long side in the width direction Y and a short side in the height direction Z. Both ends of the solid wire portion W1b in the height direction Z have outer peripheral surfaces provided with wire-side uneven patterns W1c.

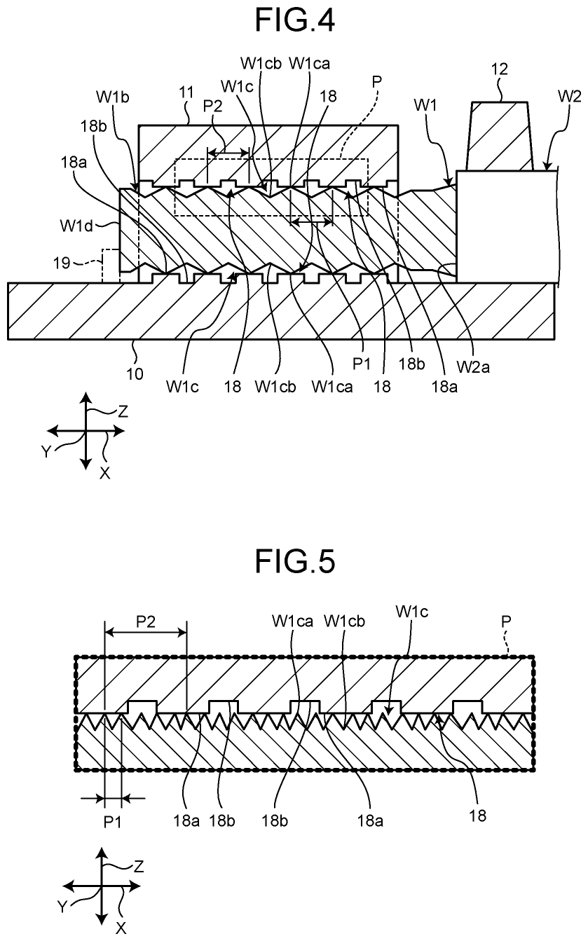

As illustrated in FIGS. 1 and 2, the wire-side uneven patterns W1care formed on both surfaces of the solid wire portion W1b in the height direction Z and have continuous recesses and protrusions from the end W1d toward the insulating sheath W2 along the axial direction X. As illustrated in FIG. 4, the wire-side uneven patterns W1c has a cross section shaped like a triangular wave when viewed from the width direction Y.

In two wire-side uneven patterns W1cformed in the solid wire portion W1b, the wire-side uneven pattern W1c on the side closer to the crimp terminal 2 faces a base 10 of the crimp terminal 2 (to be described) in a positioned state where the wire W is placed at a crimp position relative to the crimp terminal 2 as illustrated in FIG. 2. Furthermore, in the two wire-side uneven patterns W1cformed in the solid wire portion W1b, the wire-side uneven pattern W1con the opposite side of the crimp terminal 2 faces barrel members 11, 11 of the crimp terminal 2 (to be described) in a crimped state where the crimp terminal 2 is crimped to the wire Was illustrated in FIG. 4.

A plurality of protrusions W1ca and a plurality of recesses W1cb included in the wire-side uneven patterns W1c are formed to have a constant height in the height direction Z of each protrusion W1ca and each recess W1cb. The wire-side uneven patterns W1c have a constant interval (pitch P1) between adjacent protrusions W1ca. The pitch P1 herein is an interval between vertices of adjacent protrusions W1ca. In the wire-side uneven patterns W1c, an interval between adjacent recesses W1cb is equal to the pitch P1.

The crimp terminal 2 is a terminal fitting to which the wire W is electrically connected and to which a conductive mating terminal is connected. The crimp terminal 2 includes an electrical connecting portion 3, a coupling portion 4, and a wire crimp portion 5. The electrical connecting portion 3, the coupling portion 4, and the wire crimp portion 5 are formed of a conductive metal member in an integrated manner. For example, in the crimp terminal 2, a plate is molded by various processes such as punching, pressing, and bending according to shapes that correspond to the electrical connecting portion 3, the coupling portion 4, the wire crimp portion 5, and other parts. These parts are formed three-dimensionally in an integrated manner. In the crimp terminal 2, the electrical connecting portion 3, the coupling portion 4, and the wire crimp portion 5 are aligned in this order from one side to the other side along the axial direction X and are coupled to each other.

The electrical connecting portion 3 is electrically connected to the mating terminal. The electrical connecting portion 3 in FIG. 1 is indicated by a dashed line and is partially omitted. The electrical connecting portion 3 herein is a female terminal but may be a male terminal. In a case where the electrical connecting portion 3 has the shape of a female terminal, the electrical connecting portion 3 is electrically connected to the mating terminal having the shape of a male terminal. The electrical connecting portion 3 is not limited to a structure that is electrically connected to the mating terminal and may be electrically connected to various conductive members such as grounding member. In this case, the electrical connecting portion 3 may have the shape of what is called a round terminal (LA terminal) which is fastened to, for example, a grounding member.

The coupling portion 4 is interposed between the electrical connecting portion 3 and the wire crimp portion 5, being configured to couple the electrical connecting portion 3 and the wire crimp portion 5 to make them conductive. In the crimp terminal 2, the electrical connecting portion 3 and the wire crimp portion 5 are electrically connected via the coupling portion 4, and the electrical connecting portion 3 and the conductor W1 of the wire W are electrically connected via the wire crimp portion 5 and become conductive.

The wire crimp portion 5 is a portion to which the wire W is connected and electrically connects the end of the wire W and the crimp terminal 2. The wire crimp portion 5 is swaged and crimped to the end of the wire W and disposed in the end of the wire W. The wire crimp portion 5 includes the base 10 and barrel members 11 and 12. The wire crimp portion 5 is swaged and crimped to the wire W by the base 10 and the barrel members 11 and 12. A pair of barrel members 11 faces each other in the width direction Y. A pair of barrel members 12 faces each other in the width direction Y. In this manner, the wire crimp portion 5 includes the base 10 and the two pairs of barrel members 11, 11 and 12, 12.

In the wire crimp portion 5, the base 10 and the two pairs of barrel members 11, 11 and 12, 12 constitute a conductor crimp portion 14, an intermediate portion 15, and a sheath crimp portion 16. In other words, the wire crimp portion 5 includes the conductor crimp portion 14, the intermediate portion 15, and the sheath crimp portion 16 formed by the base 10 and the two pairs of barrel members 11, 11 and 12, 12.

The conductor crimp portion 14 includes a part of the base 10 and the pair of barrel members 11, 11. The intermediate portion 15 includes a part of the base 10. The sheath crimp portion 16 includes a part of the base 10 and the pair of barrel members 12, 12. In the wire crimp portion 5, the conductor crimp portion 14, the intermediate portion 15, and the sheath crimp portion 16 are aligned in this order from the coupling portion 4 toward the opposite side along the axial direction X and are connected to each other. The wire crimp portion 5 is of what is called an separate barrel type in which the pair of barrel members 11, 11 and the pair of barrel members 12, 12 are divided by the intermediate portion 15.

Specifically, the base 10 is a portion that extends along the axial direction X and becomes a bottom wall of the wire crimp portion 5 formed into a substantially U shape before the crimp terminal 2 is crimped. The base 10 is formed into a plate having a thickness along the height direction Z. The end of the wire W is placed on the base 10 at the time of crimping. To one side of the base 10 in the axial direction X, the electrical connecting portion 3 is connected via the coupling portion 4. Each part of the base 10 including the intermediate portion 15 has both ends in the width direction Y rising along the height direction Z.

The pair of barrel members 11, 11 constitutes the conductor crimp portion 14 together with a part of the base 10. The conductor crimp portion 14 is swaged and crimped to the conductor W1 of the wire W and electrically connected to the conductor W1. The conductor crimp portion 14 is disposed on the side closer to the electrical connecting portion 3 in the axial direction X in the wire crimp portion 5.

The pair of barrel members 11, 11 has a band shape extending from both sides of the base 10 in the width direction Y in the conductor crimp portion 14. The barrel members 11, 11 wrap around the conductor W1 of the wire W with the base 10 and are swaged and crimped to the conductor W1. The pair of barrel members 11, 11 is a portion that become a side wall of the wire crimp portion 5 formed into a U shape before the crimping. One of the pair of barrel members 11, 11 extends from the base 10 to one side in the width direction Y, and the other extends from the base 10 to the other side in the width direction Y. Before being swaged and crimped to the conductor W1 of the wire W (see FIG. 1), the pair of barrel members 11, 11 is bent with respect to the base 10 and is formed into a substantially U shape together with the base 10.

The pair of barrel members 11, 11 is wound around the conductor W1, and then, swaged and crimped to the conductor W1. Lengths of the barrel members 11, 11 from bottoms of the base 10 side to tips are designed in such a manner that the tips do not overlap each other. With the base 10 and the pair of barrel members 11, 11, the conductor crimp portion 14 wraps around the outer side of the solid wire portion W1b positioned between the pair of barrel members 11, 11 and is swaged and crimped to the solid wire portion W1b. In the base 10 and the pair of barrel members 11, 11, the conductor crimp portion 14 has a terminal-side uneven pattern 18 in a part that comes into contact with the solid wire portion W1b.

The terminal-side uneven pattern 18 is what is called a serration for increasing a contact area with the solid wire portion W1b and for enhancing contact stability and adhesion strength. As illustrated in FIGS. 1 and 2, in the base 10 and the pair of barrel members 11, 11, the terminal-side uneven pattern 18 has continuous recesses and protrusions from one side to the other side in the axial direction X. As illustrated in FIG. 4, the terminal-side uneven pattern 18 has a cross section shaped like a rectangular wave as viewed in the width direction Y.

As illustrated in FIG. 2, in the terminal-side uneven pattern 18 formed in the conductor crimp portion 14, parts that are on the base 10 face the wire-side uneven pattern W1c that is placed on one side (lower side) of the solid wire portion W1b in the height direction Z in the positioned state where the wire W is placed at the crimp position with respect to the crimp terminal 2.

A plurality of protrusions 18a and a plurality of recesses 18b included in the terminal-side uneven pattern 18 are formed to have a constant height in the height direction Z of each protrusion 18a and each recess 18b. The terminal-side uneven pattern 18 has a constant interval (pitch P2) between adjacent protrusions 18a. The pitch P2 herein is an interval between the centers of width of adjacent protrusions 18a in the axial direction X. In the terminal-side uneven pattern 18, an interval between adjacent recesses 18b is equal to the pitch P2. In this embodiment, the width of each protrusion 18a in the axial direction X is designed to be relatively longer than the width of each recess 18b in the axial direction X.

The conductor exposed portion W1a and the wire crimp portion 5 in this embodiment have the protrusions W1ca in the wire-side uneven patterns W1c and the protrusions 18a in the terminal-side uneven pattern 18 brought into contact with each other at least at one point in the crimped state where the wire crimp portion 5 is crimped to the conductor exposed portion W1a. Specifically, at least one of the plurality of protrusions W1ca in the wire-side uneven patterns W1c and at least one of the plurality of protrusions 18a in the terminal-side uneven pattern 18 are in contact with each other in the height direction Z in the crimped state.

As illustrated in FIG. 4, in the crimped state, the wire-side uneven pattern W1c of the two wire-side uneven patterns W1c formed in the solid wire portion W1b which is closer to the base 10 has at least one of the plurality of protrusions W1ca abutting on at least one of the plurality of protrusions 18a of the terminal-side uneven pattern 18 closer to the base 10. In addition, as illustrated in FIG. 4, in the crimped state, the wire-side uneven pattern W1c of the two wire-side uneven patterns W1c formed in the solid wire portion W1b which is closer to the barrel members 11 has at least one of the plurality of protrusions W1ca abutting on at least one of the plurality of protrusions 18a of the terminal-side uneven pattern 18 closer to the barrel members 11.

The pitch P1 of the wire-side uneven patterns W1c of this embodiment is relatively determined according to the pitch P2 of the terminal-side uneven pattern 18. In other words, the terminal-equipped wire 1 of this embodiment preferably has the pitch P1 and the pitch P2 satisfying P1/P2<1, as illustrated in FIG. 5, in order to increase contact points between the plurality of protrusions W1ca and the plurality of protrusions 18a. In this case, the pitch P1 becomes relatively small relative to the pitch P2 (P1<P2).

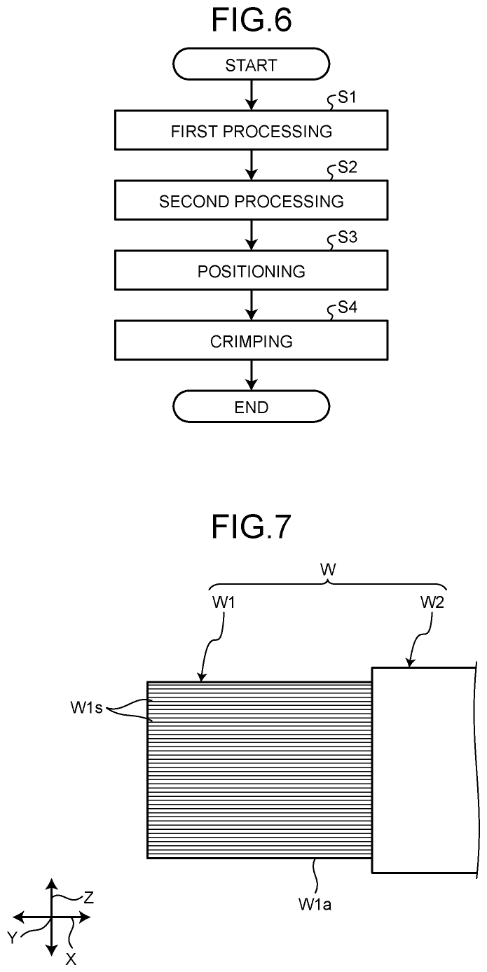

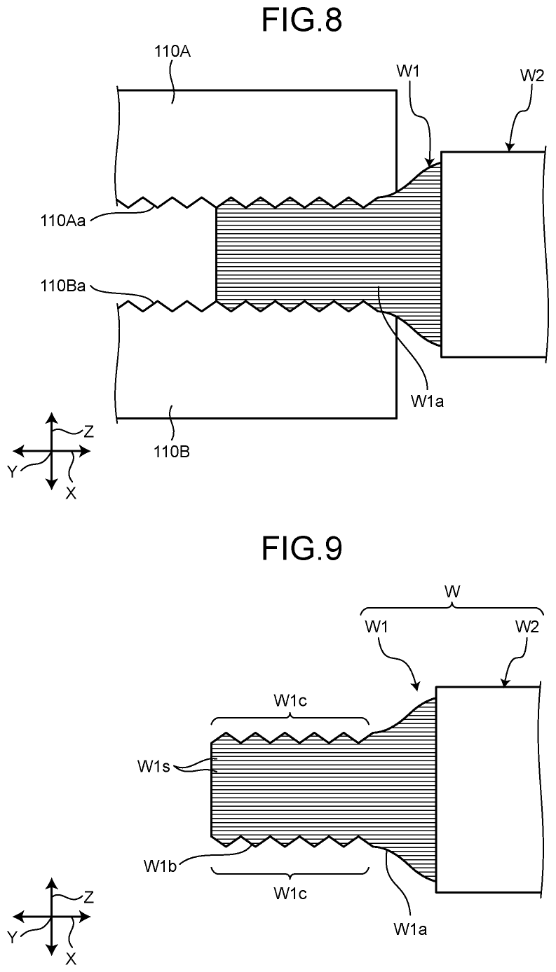

Next, a method for manufacturing the terminal-equipped wire 1 will be described with reference to FIGS. 6 to 9 (including FIGS. 1 to 5). The following method for manufacturing the terminal-equipped wire 1 may be manually performed by an operator using various devices, instruments, jigs, and the like or may be automatically performed by various manufacturing devices.

As illustrated in FIG. 6, the method for manufacturing the terminal-equipped wire 1 of this embodiment includes, for example, first processing (Step S1) , second processing (Step S2), positioning (Step S3), and crimping (Step S4).

In the first processing, the plurality of strands W1s is solidified in the conductor exposed portion W1a exposed from the end W2a of the insulating sheath W2 of the wire W to form the solid wire portion W1b, and the wire-side uneven patterns W1c are formed on surfaces of the solid wire portion W1b along the axial direction X of the wire W. In the first processing, when the conductor exposed portion W1a is made into a solid wire to form the solid wire portion W1b, the conductor exposed portion W1a illustrated in FIG. 7 is fixed by a pair of fixing jigs (not illustrated) facing each other in the width direction Y, and ultrasonic bonding is performed using a pair of processing jigs 110A and 110B (what is called anvils and horns) facing each other in the height direction Z. The ultrasonic bonding may be press molding (forming). The wire-side uneven patterns W1c are formed on a processed surface 110Aa of the processing jig 110A and a processed surface 110Ba of the processing jig 110B. The pair of processing jigs 110A, 110B pressurizes the conductor exposed portion W1a to sandwich the conductor exposed portion W1a from both sides in the height direction Z by the processed surface 110Aa and the processed surface 110Ba, whereby the wire-side uneven patterns W1c are formed on outer peripheral surfaces at both ends of the solid wire portion W1b in the height direction Z (FIG. 9).

Next, in the second processing, with respect to the crimp terminal 2 which includes the wire crimp portion 5 to be crimped to the end W2a of the insulating sheath W2 and the solid wire portion W1b and includes the electrical connecting portion 3 to be coupled to the wire crimp portion 5 and become conductive and electrically connected to a mating terminal, a terminal-side uneven pattern is formed along the axial direction X on a contact surface of the wire crimp portion 5 to be in contact with the solid wire portion W1b.

Next, in the positioning, the wire W is positioned relative to the wire crimp portion 5, bringing the protrusions W1ca in the wire-side uneven patterns W1c into contact with the protrusions 18a in the terminal-side uneven pattern 18 at least at one point.

Next, in the crimping, the wire crimp portion 5 is crimped to the solid wire portion W1b. In this crimping, the wire crimp portion 5 on which the wire W is placed is processed with a pair of processing jigs 100A, 100B facing each other in the height direction Z (FIG. 3). The pair of processing jigs 100A, 100B (indicated by a dashed double-dotted line in FIG. 3) pressurizes the wire crimp portion 5 to sandwich the wire crimp portion 5 from both sides in the height direction Z, whereby the wire crimp portion 5 is crimped to the wire W. Accordingly, in the method for manufacturing the terminal-equipped wire 1 according to the embodiment, the protrusions 18a press the protrusions W1ca toward the wire in the height direction Z at points where the protrusions 18a in the terminal-side uneven pattern 18 and the protrusions W1ca in the wire-side uneven patterns W1c are in contact with each other, whereby the protrusions W1ca are deformed toward both sides in the axial direction X centering on the contact points with the protrusions 18a. As a result of the deformation, the method for manufacturing the terminal-equipped wire 1 enables deliberate manufacturing of a high surface pressure point between the solid wire portion W1b and the wire crimp portion 5 in the terminal-equipped wire 1. In addition, the method for manufacturing the terminal-equipped wire 1 according to the embodiment enables breaking of a metal oxide film formed at an interface between the solid wire portion W1b and the wire crimp portion 5 in the high surface pressure point and achieves stable conduction between the crimp terminal 2 and the wire W.

As described above, in the terminal-equipped wire 1 according to this embodiment, the conductor exposed portion W1a of the wire W constitutes the solid wire portion W1b obtained by solidifying the plurality of strands W1s into a solid wire, and the wire-side uneven patterns W1c are formed on the surfaces of the solid wire portion W1b. In the wire crimp portion 5 of the crimp terminal 2, the terminal-side uneven pattern 18 is formed along the axial direction X on the surface that comes into contact with the conductor exposed portion W1a. In the crimped state where the wire crimp portion 5 is crimped to the conductor exposed portion W1a, the conductor exposed portion W1a and the wire crimp portion 5 have the protrusions W1ca in the wire-side uneven patterns W1c and the protrusions 18a in the terminal-side uneven pattern 18 brought into contact with each other at least at one point.

Due to this configuration, in the terminal-equipped wire 1 in the crimped state, the protrusions W1ca in the wire-side uneven patterns W1c and the protrusions 18a in the terminal-side uneven pattern 18 come into contact with each other to break the metal oxide film formed on surfaces of the protrusions W1ca and 18a. Accordingly, the terminal-equipped wire 1 and the method for manufacturing the terminal-equipped wire 1 of this embodiment make it possible to secure conduction between the solid wire portion W1b of the wire W and the wire crimp portion 5 of the crimp terminal 2 by breaking the metal oxide film, thereby achieving stable conduction between the crimp terminal 2 and the wire W.

The method for manufacturing the terminal-equipped wire 1 according to this embodiment includes the first processing, the second processing, the positioning, and the crimping (Step S4). In the first processing, the solid wire portion W1b is formed in the conductor exposed portion W1a, and the wire-side uneven patterns W1c are formed on the surfaces of the solid wire portion W1b along the axial direction X of the wire W. In the positioning, the solid wire portion W1b is positioned relative to the wire crimp portion 5, bringing the protrusions W1ca in the wire-side uneven patterns W1c into contact with the protrusions 18a in the terminal-side uneven pattern 18 at least at one point. In the crimping, the wire crimp portion 5 is crimped to the solid wire portion W1b.

According to the method for manufacturing the terminal-equipped wire 1 of the embodiment, with the above configuration, the protrusions 18a press the protrusions W1ca toward the wire in the height direction Z at the points where the protrusion 18a and the protrusions W1ca are in contact with each other, thereby deforming the protrusions W1ca toward both sides in the axial direction X centering on the contact points with the protrusions 18a. Accordingly, the method for manufacturing the terminal -equipped wire 1 enables deliberate manufacturing of the high surface pressure point between the solid wire portion W1b and the wire crimp portion 5 and breaking of the metal oxide film formed at the interface between the solid wire portion W1b and the wire crimp portion 5 in the high surface pressure point, which achieves stable conduction between the crimp terminal 2 and the wire W.

In addition, in the terminal-equipped wire 1 and the method for manufacturing the terminal-equipped wire 1 according to this embodiment, the solid wire portion W1b and the wire crimp portion 5 satisfy P1/P2<1 where P1 is a pitch between the protrusions W1ca in the wire-side uneven patterns W1c and P2 is a pitch between the protrusions 18a in the terminal-side uneven pattern 18. Accordingly, the terminal-equipped wire 1 and the method for manufacturing the terminal-equipped wire 1 relatively increase contact points between the protrusions W1ca in the wire-side uneven patterns W1c and the protrusions 18a in the terminal-side uneven pattern 18.

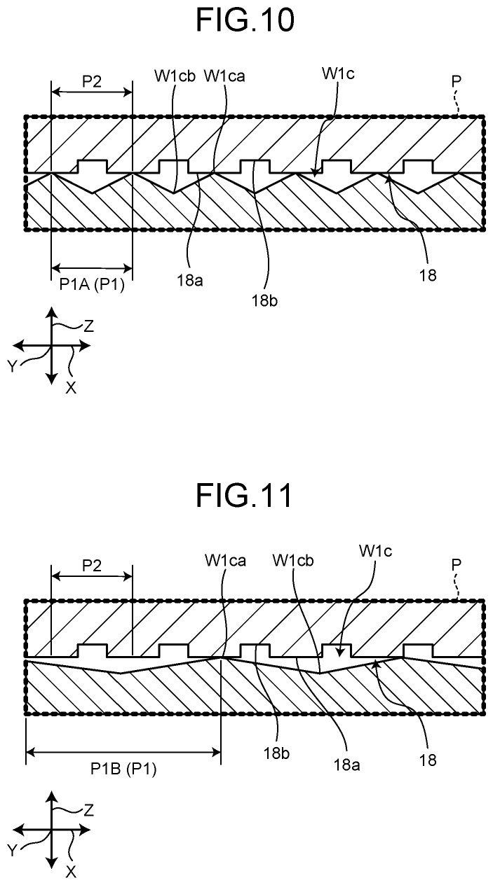

In the above embodiment, the pitch Pl between the protrusions W1ca in the wire-side uneven patterns W1c and the pitch P2 between the protrusions 18a in the terminal-side uneven pattern 18 satisfy P1/P2<1 but the present invention is not limited thereto. FIGS. 10 and 11 are schematic views illustrating contact between a wire-side uneven pattern and a terminal-side uneven pattern according to modifications of the embodiment.

A pitch P1A (P1) between the protrusions W1ca in the wire-side uneven patterns W1c and a pitch P2 between the protrusions 18a in the terminal-side uneven pattern 18 illustrated in FIG. 10 are equal and satisfy P1A/P2=1. With the pitch PIA and the pitch P2 satisfying P1A/P2=1, as illustrated in the drawing, when the protrusions W1ca in the wire-side uneven patterns W1c and the protrusions 18a in the terminal-side uneven pattern 18 are at positions facing each other in the height direction Z, it is possible to secure contact between the protrusions W1ca and the protrusion 18a. In the terminal-equipped wire 1 according to the modification, the wire crimp portion 5 includes a restricting portion 19 (indicated by dashed line in FIG. 2 and dashed double-dotted line in FIG. 4), as illustrated in FIGS. 2 and 4, that restricts the solid wire portion W1b from moving in the axial direction X of the wire W in the positioned state where the solid wire portion W1b is positioned in the wire crimp portion 5. The restricting portion 19, for example, protrudes from the base 10 toward the wire W and forms a protrusion extending in the width direction Y. When the end W1d of the solid wire portion W1b abuts from the wire side in the axial direction X in the positioned state, the restricting portion 19 restricts the solid wire portion W1b from moving toward a mating terminal in the axial direction X. Adjusting a positional relation between the terminal-side uneven pattern 18 and the restricting portion 19 in the axial direction X according to the pitch P1A (or the pitch P2) makes it possible to align the protrusions W1ca and the protrusions 18a at positions facing each other in the height direction Z.

In the terminal-equipped wire 1 and the method for manufacturing the terminal-equipped wire 1 according to the modification of the embodiment, the solid wire portion W1b and the wire crimp portion 5 satisfy P1A(P1)/P2=1 where P1A is the pitch between the protrusions W1ca in the wire-side uneven patterns W1c and P2 is the pitch between the protrusions 18a in the terminal-side uneven pattern 18, and the wire crimp portion 5 includes the restricting portion 19 restricts the conductor exposed portion W1a from moving in the axial direction X relative to the wire crimp portion 5. Accordingly, the terminal-equipped wire 1 and the method for manufacturing the terminal-equipped wire 1 according to the modification ensure contact between the protrusions W1ca and the protrusions 18a.

A pitch P1B (P1) between the protrusions W1ca in the wire-side uneven patterns W1c and a pitch P2 between the protrusions 18a in the terminal-side uneven pattern 18 illustrated in FIG. 11 are not equal but satisfy P1B/P2>1. With the pitch P1B and the pitch P2 satisfying PIB/P2>1, the number of contact points between the plurality of protrusions W1ca and the plurality of protrusions 18a tends to decrease as compared with a case where P1/P2<1 is satisfied. With the pitch P1B and the pitch P2 satisfying P1B/P2>1, when the protrusions W1ca in the wire-side uneven patterns W1c and the protrusions 18a in the terminal-side uneven pattern 18 are at positions facing each other in the height direction Z, contact between the protrusions W1ca and the protrusion 18a can be secured as illustrated in FIG. 11. In this case, since the wire crimp portion 5 has the restricting portion 19, it is possible to ensure contact between the protrusions W1ca and the protrusions 18a.

In the terminal-equipped wire 1 and the method for manufacturing the terminal-equipped wire 1 according to the modification of the embodiment, the solid wire portion W1b and the wire crimp portion 5 satisfy PIB (P1)/P2>1 where P1B is the pitch between the protrusions W1ca in the wire-side uneven patterns W1c and P2 is the pitch between the protrusions 18a in the terminal-side uneven pattern 18, and the wire crimp portion 5 includes the restricting portion 19. Accordingly, the terminal-equipped wire 1 and the method for manufacturing the terminal-equipped wire 1 according to the modification ensure contact between the protrusions W1ca and the protrusions 18a.

In the above embodiment and modifications, the wire-side uneven patterns W1c have a cross section shaped like a triangular wave when viewed from the width direction Y as illustrated in FIG. 4, but the present invention is not limited thereto. For example, the cross section of the wire-side uneven patterns W1c may be shaped like a rectangular wave when viewed from the width direction Y. In this case, the cross section of the terminal-side uneven pattern 18 may be shaped like a triangular wave when viewed from the width direction Y.

In the above embodiment and modifications, the width of the protrusions 18a in the axial direction X is designed to be relatively longer than the width of the recesses 18b in the axial direction X, but the present invention is not limited thereto. For example, the width of the protrusions 18a in the axial direction X may be equal to or may be designed relatively shorter than the width of the recesses 18b in the axial direction X.

In the aforementioned embodiment and the modifications, the restricting portion 19 protrudes from the base 10 toward the wire W and forms a protrusion extending in the width direction Y, but the present invention is not limited thereto. For example, the restricting portion 19 may be disposed at ends of the barrel members 11, 11 on the side closer to the coupling portion 4 in the axial direction X and may have a substantially L-shaped cross-section when viewed from the width direction Y.

A terminal-equipped wire and a method for manufacturing a terminal-equipped wire according to the present embodiment enable efficient breaking of a metal oxide film between a wire and a crimp terminal. Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A terminal-equipped wire comprising:
a wire in which a conductor having conductivity is sheathed with an insulating sheath having an insulating property; and
a crimp terminal including a wire crimp portion crimped to an end of the insulating sheath and a conductor exposed portion which is a part of the conductor exposed from the end, and an electrical connecting portion coupled to the wire crimp portion to be conductive and electrically connected to a mating terminal,
wherein the conductor exposed portion has a solid wire portion formed by solidifying a plurality of strands into a solid wire and a wire-side uneven pattern formed on a surface of the solid wire portion along an axial direction of the wire,
the wire crimp portion has a terminal-side uneven pattern formed along the axial direction on a contact surface in contact with the conductor exposed portion, and
the conductor exposed portion and the wire crimp portion have protrusions in the wire-side uneven pattern and protrusions in the terminal-side uneven pattern brought into contact with each other at least at one point in a crimped state where the wire crimp portion is crimped to the conductor exposed portion.

2. The terminal-equipped wire according to claim 1, wherein the conductor exposed portion and the wire crimp portion satisfy P1/P2<1 where P1 is a pitch between the protrusions in the wire-side uneven pattern and P2 is a pitch between the protrusions in the terminal-side uneven pattern.

3. The terminal-equipped wire according to claim 1,
wherein the conductor exposed portion and the wire crimp portion satisfy P1/P2≥1 where P1 is a pitch between the protrusions in the wire-side uneven pattern and P2 is a pitch between the protrusions in the terminal-side uneven pattern, and
the wire crimp portion includes a restricting portion that restricts the conductor exposed portion from moving in the axial direction of the wire in a positioned state where the conductor exposed portion is positioned in the wire crimp portion.

4. A method for manufacturing a terminal-equipped wire, the method comprising:
first processing to form a solid wire portion by solidifying a plurality of strands into a solid wire in a conductor exposed portion exposed from an end of an insulating sheath of a wire in which a conductor having conductivity is sheathed with an insulating sheath having an insulating property and to form a wire-side uneven pattern along an axial direction of the wire on a surface of the solid wire portion;
second processing to form a terminal-side uneven pattern along the axial direction on a contact surface of a wire crimp portion of a crimp terminal coming in contact with the conductor exposed portion, the crimp terminal including the wire crimp portion crimped to the end of the insulating sheath and to the conductor exposed portion and an electrical connecting portion coupled to the wire crimp portion to be conductive and electrically connected to a mating terminal;
positioning of the conductor exposed portion on the wire crimp portion, bringing protrusions in the wire-side uneven pattern and protrusions in the terminal-side uneven pattern into contact with each other at least at one point; and
crimping of the wire crimp portion to the conductor exposed portion.
